(19) United States
(12) Patent Application Publication
(10) Pub. No.: US 2004/0200923 A1
(43) Pub. Date: Oct. 14, 2004

(54) Instrumentation supporting panel

(76) Inventor: John Randy Lee, Strathroy (CA)

Correspondence Address: John Randy Lee, 4615 Egremont Drive, Strathroy, ON, N7G 3H6, CA

(21) Appl. No.: 10/410,364

(22) Filed: Apr. 10, 2003

(51) Int. Cl. B64C 1/00

(52) U.S. Cl. 244/1 R

(57) ABSTRACT

An instrumentation panel has a panel display surface and an opposed surface, with an interconnected web of raised material lands arranged across the display surface of the panel and which display surface is otherwise generally characterized by interstitial depressions, and wherein the display surface lands are adapted to receive at least one instrumentation housing in fixed-supported relation there through. In one embodiment, the opposed surface also comprises a plurality of raised complementary lands, preferably arranged in a transverse intersecting pattern relative to the pattern of the raised lands of the display surface. In another embodiment, the lands form a pattern that provides visual cues that aid the viewer in rapidly centering the instrumentation within the visual field and preferably, the lands and the depressions on the display surface receive respective but mutually visually contrasting surface treatments.

### FIELD OF THE INVENTION

The present invention relates to instrumentation panels, particularly those offering light weight rigidity and visual cues for rapidly centering a users visual field.

### BACKGROUND OF THE INVENTION

Customized instrument panel layouts is a desirable option for privately owned vehicles—and especially it seems, for private “kit” planes where purchasers often enjoy being able to put something unique of their own into the design.

Weight and strength are almost always conflicting issues, particularly in aircraft applications. Moreover, anything that enhances the ability to center and focus on the panel instrumentation is important. Visual queues that “point and frame” the instrument within an observers visual field can be crucial where reaction time is of vital importance to the operation of the plane.

Accordingly, there remains a need in the art for simple, light weight, strong, customized instrument panels, their manufacture, and broad but readily facilitated access to the customization of orders.

### SUMMARY OF THE INVENTION

In accordance with one aspect of the present invention, there is provided an instrumentation panel comprising a panel display surface and an opposed surface. An interconnected web of raised material lands arranged across the display surface of the panel. These lands are adapted to receive at least one instrumentation housing in fixed-supported relation there through and preferably also define a frame surrounding at least a portion of the periphery of the panel. The display surface is otherwise generally characterized by interstitial depressions.

Preferably the panel is adapted to receive and support a plurality of such instrument housings, which may or may not include integral housings multiple instrument clusters.

In a particular preferred embodiment, the opposed surface also comprises a plurality of raised “complementary” lands. Complementary in this sense is a reference to such land's contribution to the rigidity of the overall panel, and especially in cases where these lands cooperate with those on the display surface, as for example in the case where at least some of the complementary lands on the opposed surface are arranged in a transverse intersecting pattern relative to the pattern of the raised lands of the display surface.

In accordance with yet another preferred aspect of the present invention, lands form a pattern that provides visual cues that aid the viewer in rapidly centering the instrumentation within the visual field. Preferably in such embodiments, the lands and the depressions receive respective, mutually visually contrasting surface treatments—as in the case where the depressions are treated to a low or non-reflective surface treatment, while the lands are highly reflective.

The present invention also relates to a method for producing an instrumentation panel comprising the steps of:

machine-relieving depressions from panel stock to leave behind raised lands on at least said panel display surface

applying a uniform surface finishing treatment to said panel display surface selectively refinishing said raised lands on said panel display surface to

The method can also advantageously include the further step of machine-relieving depressions by removing materials from the opposed surface to leave behind raised lands thereon, too.

In accordance with a sill further aspect of the present invention, there is provided a method according wherein an internet order user interface is provided, whereby a user provides desired instrument location centers on a graphic interface, and tags each such location with an instrument manufacturer, type and model number in response to prompts for same, correlates the information that is provided with mounting configurations corresponding to instrument ID, fits the instruments around the centers and defines supporting lands, including provision for mounting hardware thereon, creates a web calculated to minimize weight for a maximum of rigidity, stores the pattern as a CNC file, and transmits the file to a CNC machine for relief machining of a stock plate.

### INTRODUCTION TO THE DRAWINGS

FIG. 1 is a plan view of the display surface of an instrument panel according to the present invention;

FIG. 2 is a sectional view taken across line A-A in FIG. 1; and,

FIG. 3 is an enlarged portion of the sectional view depicted in FIG. 2.

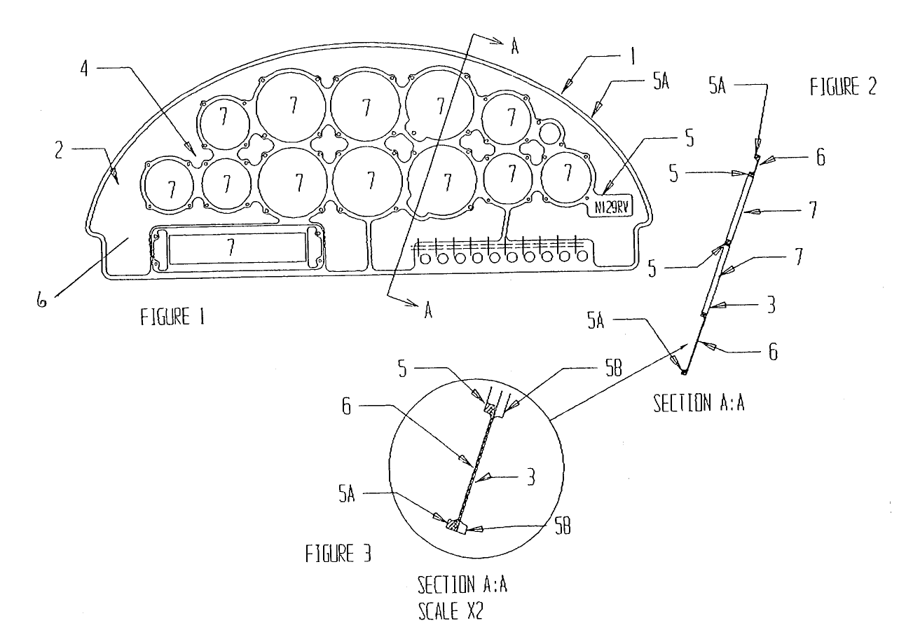

### DETAILED DESCRIPTION OF THE INVENTION

Referring now to the drawings in general, and in reference to the particularly preferred form of the present illustrated therein, there is provided an instrumentation panel 1 comprising a panel display surface 2 and an opposed surface 3 (seen in FIGS. 2 and 3 only), with an interconnected web 4 of raised material lands 5 arranged across the display surface 2 of panel 1. Display surface 2 is otherwise generally characterized by interstitial depressions 6. Lands 5 are adapted to receive at least one instrumentation housing (not shown) in fixed-supported relation there through. Panel 1 is adapted to receive a plurality of such housings (within the various openings 7) in supported relation, and includes provision for support of an integrated multiple instrument cluster, (not shown).

In an alternative embodiment, the panel's interconnected web 4 includes a raised material land portion 5a defining a frame surrounding at least a portion of the periphery of the panel, and the opposed surface 3 comprises a plurality of raised complementary lands 5b, (shown only for example, and in FIG. 3). Although not illustrated, at least some of the complementary lands on the opposed surface 3 can be advantageously arranged in a transverse intersecting pattern relative to the pattern of the raised lands of the display surface.

The lands and the depressions (at least on the display surface) have visually contrasting surface treatments—in this case with the depressions having been sand blasted to produce a pebbled, light-diffusing pattern (which is exemplary of preferred low or non-reflective finishes), and the lands polished to draw additional attention to them and the instruments they surround. The network of lands themselves form a pattern that provides visual cues that aid the viewer in rapidly centering the instrumentation within the visual field—and the contrasting finish further reinforces this effect.

In accordance with another aspect of the present invention, there is provided a method of producing an instrumentation panel comprising the steps of: machine-relieving depressions from panel stock to leave behind raised lands on at least said panel display surface; applying a uniform surface finishing treatment to said panel display surface; and, selectively refinishing said raised lands on said panel display surface so that it differs from the uniform surface treatment, perhaps in some complementary or even contrasting way.

Either, or both sides of the panel stock can be machine-relieved in this way, to produce the depressions, as for example by removing material from the opposed surface to leave behind raised lands thereon.

In accordance with the preferred practice, this method is carried out using a computer numeric control system employing a milling machine. A computer stores and provides the instructions directly from some form of memory (e.g. magnetically imprinted information on so-called “floppy” or “hard” drives; or optically on compact discs). The milling machine, operating under the numerical control of the computer, relieves the appropriate profiles from the instrument panel stock material.

The process generally involves a designer making a drawing of the instrument panel with the instrument layout superimposed over its surface, on a CAD (Computer Assisted Design) system, or the like. The CAD system describes each line (e.g. as spatial co-ordinates, such as x₁, y₁, z₁, to x₂, y₂, z₂). This basic information is then processed further using a CAM (Computer Assisted Machining) system. This process supplies more information, which in combination with the CAD information defines a shape to be machined. The CAM system is programmed with machining related information (e.g. what tool selection to make, to use how fast to turn the tool where to start/finish, tool radius and what surface of the panel is currently being presented to the tooling for machining). The thus generated files can be E-mailed, stored, edited etc. In operation, the files are interrogated by a computer numerical control system and the milling machine, in response to corresponding control signals from that CNC system, machines the required patterns from the selected stock blank.

In accordance with one aspect of the present invention, an internet ordering user interface is provided, whereby a user selectively positions defined graphical objects corresponding to various instruments within a graphical perimeter representing an instrument panel surface. The graphical objects, and their relative positioning are correlated and compiled into a composite format, (either as a CAD file, or some informational equivalent thereof), with a web of raised lands being interpolated between proximal portions of adjacent instrument's peripheries. The user interface then permits the user to place an order for the thus designed instrument panel to the instrument panel manufacturer by forwarding the CAD information directly to an order processing queue at the manufacturer's facilities, where the order can be further processed and the information passed to the CAM and CNC systems as described above. An optional feature of this interface includes the ability to collaterally place an electronically facilitated order for the selected instruments included within the panel perimeter, from the instrument manufacturer.

1. An instrumentation panel comprising a panel display surface and an opposed surface, with an interconnected web of raised material lands arranged across the display surface of said panel and which display surface is otherwise generally characterized by interstitial depressions, and wherein said lands are adapted to receive at least one instrumentation housing in fixed-supported relation there through.

2. The panel according to claim 1, adapted to receive a plurality of such housings in said supported relation.

3. The panel according to claim 2, wherein one or more of said housings is a support for an integrated multiple instrument cluster.

4. The panel according to claim 1, wherein said interconnected web includes a raised material land portion defining a frame surrounding at least a portion of the periphery of said panel.

5. A panel according to claim 1 wherein the opposed surface comprises a plurality of raised complementary lands.

6. The panel according to claim 5, wherein at least some of the complementary lands on said opposed surface are arranged in a transverse intersecting pattern relative to the pattern of the raised lands of the display surface.

7. The panel according to claim 1 wherein said lands and said depressions receive a visually contrasting surface treatment.

8. The panel according to claim 7 wherein said lands form a pattern that provides visual cues that aid the viewer in rapidly centering the instrumentation within the visual field.

9. The panel according to claim 1 wherein said depressions are treated to a low or non-reflective surface treatment.

10. A method of producing an instrumentation panel comprising the steps of:
machine-relieving depressions from panel stock to leave behind raised lands on at least said panel display surface
applying a uniform surface finishing treatment to said panel display surface
selectively refinishing said raised lands on said panel display surface to differ from said uniform surface treatment.

11. The method according to claim 10, wherein machine-relieving of said depressions further includes removing materials from said opposed surface to leave behind raised lands thereon.

12. The method according to claim 10, wherein an internet ordering user interface is provided, whereby a user selectively positions defined graphical objects corresponding to various selected instruments within a graphical perimeter representing an instrument panel surface on a web page otherwise adapted to process orders for instrument panels with specified layouts.

13. The method according to claim 12, wherein information defining said graphical objects, and their relative positioning within said perimeter, is correlated and compiled into a composite format, and a web of raised lands is interpolated between proximal portions of adjacent instrument's peripheries.

14. The method according to claim 13, wherein said interface further includes provision for the collateral placement of an electronically facilitated order for the selected instruments included within the panel perimeter.
